(19) United States
(12) Patent Application Publication
(10) Pub. No.: US 2006/0221918 A1
(43) Pub. Date: Oct. 5, 2006

(54) System, method and computer program product for providing content to a remote device

(75) Inventor: Yunbiao Wang, Fremont, CA (US)

Correspondence Address: SQUIRE, SANDERS & DEMPSEY L.L.P, 600 HANSEN WAY, PALO ALTO, CA, 94304-1043, US

(73) Assignee: Hitachi, Ltd.

(21) Appl. No.: 11/097,505

(22) Filed: Apr. 1, 2005

(51) Int. Cl. H04Q 7/24

(52) U.S. Cl. 370/338

(57) ABSTRACT

Embodiments of a system, method and computer program product for providing content to a remote device are described. In one embodiment, a request to establish a link is received from a remote device via an access point in a set of access points that define a service area. A link with may then be established the remote device. An identifier may also be associated with the remote device for the newly established link so that subsequent communications made via the link can include the identifier. Communications made via the link can be monitored in the service area utilizing the identifier to determine the location of the remote device. Based on determined location of the remote device, content may be selected and sent to remote device for subsequent presentment.

### TECHNICAL FIELD

Embodiments described herein generally relate to wireless networks, and more particular content delivery systems for cognitive radio and software-defined radio.

### BACKGROUND

Currently, people cannot obtain and service providers cannot provide traffic information with fine granularity in real-time. Traditionally, broadcasting services such as radio, TV are used to provide traffic information. Such systems can cover a large area. Such traffic information usually is typically provided for a given general locality (e.g., a city) and oftentimes, this level of information is not very useful for people when the immediate traffic conditions around them are not covered by a current system, such as TV, radio. In addition, standard media broadcasting system can only focus on some important routes and do not provide traffic information for every specific location. The traffic information provided by these traditional broadcasting system do not meet most drivers' needs all of the time because drivers are often driving in areas not covered by the current system.

Current traffic broadcasting service are also unidirectional. Drivers cannot request the services or information based on their present location. For example, a driver may want to know the road conditions in his area to find out whether there is traffic congestion on his route and if so, the driver may want to find alternative routes that can be taken to avoid the congestion. Current systems cannot provide such a service. Typically in current broadcasting systems, airborne monitoring (e.g., helicopters) and listener call-ins are used to obtain current road conditions and other traffic information.

### SUMMARY

Embodiments of a system, method and computer program product for providing content to a remote device are described. In one embodiment, a request to establish a link is received from a remote device via an access point in a set of access points that define a service area. A link with may then be established the remote device. An identifier may also be associated with the remote device for the newly established link so that subsequent communications made via the link can include the identifier. Communications made via the link can be monitored in the service area utilizing the identifier to determine the location of the remote device. Based on determined location of the remote device, content may be selected and sent to remote device for subsequent presentment.

In one embodiment, the remote device comprises a cognitive radio. In another embodiment, prior to receiving the request, the remote device may monitor broadcasts in the service area for information about establishing the link. In a further embodiment, the remote device may maintain the link when passing from a communication range of one access point to a communication range of another access point in the service area.

In one embodiment, the identifier associated with the remote device may comprise a pre-assigned identifier provided by the remote device. In another embodiment, the identifier associated with the remote device may be randomly selected. In such an embodiment, the randomly assigned identifier may be returned to a pool of identifiers when the communication link is ended.

In one embodiment, the set of access points may comprise a plurality of heterogeneous access points. In another embodiment, communications made by the remote device via the communication link may include information about an access point through which the communication passes. In such an embodiment, the information about the access point includes information about an identity of the access point. As another option, the information about access point may include information about an operating range of the access point.

In one embodiment, the content may include map information about a geographic area proximate to the determined location of the remote device. In another embodiment, the content may include traffic information in a geographic area proximate to the determined location of the remote device. In such an embodiment, the service provider collects information about the locations of one or more additional remote devices located in the service area and determines traffic densities of transport channels in the service area, and wherein information relating to the traffic densities is included in the content. In a further embodiment, the content may include advertisements. In yet another embodiment, the content may include information relating to good and/or service providers in a region proximate to the remote device.

In one embodiment, an account for the remote device may be established with the identifier being associated with an account. Fees may then be charged to the account for the content transmitted to the remote device. In such an embodiment, a credit may be credited to the account for each advertisement included in the content sent to the remote device.

### BRIEF DESCRIPTION OF THE DRAWINGS

FIG. 1 is a schematic block diagram of an illustrative revenue relationship in accordance with an exemplary embodiment;

FIG. 2 is a schematic flow diagram of information exchanged between a base station/service provider and a remote device in accordance with one embodiment;

FIG. 3 is a schematic block diagram of an exemplary environment for implementing embodiments described herein;

FIG. 4 is a schematic block diagram of an exemplary service provider in accordance with an illustrative embodiment;

FIG. 5 is a schematic block diagram of an exemplary remote device in accordance with an illustrative embodiment;

FIG. 6 is a schematic diagram of an illustrative network system in accordance with an exemplary embodiment; and

FIG. 7 is a schematic diagram of a representative hardware environment in accordance with one embodiment.

### DETAILED DESCRIPTION

With the increased availability of wireless networks and devices, such networks may be useful in providing information such as traffic information to users via wireless devices anywhere and at anytime. Such networks may also be useful in providing real-time news updates that may be targeted to users at a specific geographic locations.

Embodiments described herein may use cognitive radio or other forms of wireless radio to monitor and provide traffic information in real-time. The provided information may be based on the location of drivers. In addition, a service provider can constantly monitor the density of drivers in its service area and provide any necessary adjustments of service. In one embodiment, the system may assign each device an identifier that may be either unique or temporary. A temporary ID may expire after the device moves out of the service area or when the device cannot be accessed.

Embodiments of this system do not require that all automobiles be equipped with location devices. In fact, embodiments of this system may be implemented to provide drivers with an approximate location information. On the other hand, if the automobiles can provide location information to the system, then the system may be implemented to provide information based on the exact location of the driver.

In embodiments of the system, wireless base stations may be used to provide traffic information to drivers. A base station may be equipped with a device meeting a wireless communication standard such as IEEE 802.11a or a cognitive radio wireless LAN. Using cognitive radio technology may allow the base station to support more devices enabled by different heterogeneous wireless technologies such as, for example, WiFi, WiMAX, Cellular, and Cognitive WLAN in TV band. In an cognitive radio embodiment, better channels may be selected to help improve the data rate.

In accordance with one embodiment, two kinds of wireless services may be provided. One wireless service may be based on subscription where a driver subscribes to the service by paying a certain fee. The fee may be monthly based or deposit based. The user's devices may then be assigned a unique identifier (i.e., a unique ID). As long as these devices are in the service area of the provider, this ID may be valid and can be used for obtaining services from the system.

In the second kind of wireless service, there may be no pre-assigned IDs. For devices in this type of service, when their vehicles move into a service area, the service provider can randomly assign identifiers to the vehicle's device. In most cases, these IDs may be valid as long as the wireless devices are in the service area. When the devices move out of the service area, the system may reclaim these IDs and can reassign them to other new devices in the coverage area.

The first type of devices may also be implemented so that can also turn off their unique IDS and prevent them from being provided to the system. If this occurs, the devices will then obtain a temporary ID from the service provider when they are in the service area. This process of assigning ID to each device may be implemented to help provide an efficient way to monitor the service area while protecting customers' privacy because the second type of ID may be assigned randomly and a service provider only knows that there is a device in their network with a random ID—the service provided does not need to know any other personal or private information about the owner.

For automobile usage, embodiments of the system may be implemented to provide real-time road conditions to drivers. By using the ID system, the server can track each car's speed and get the real time road traffic conditions. A driver can view the road conditions around him or her immediately through the wireless devices installed in his car. In one embodiment, the server can calculate the car's speed as follows: Using the ID, the server can know the position of car at time “t1” and the position of the car at time “t2.” The speed of the car can then be calculated based on the distance between the two positions and the difference in the time. Based on this speed, a server can display the traffic conditions for drivers. Thus embodiments of this process provide a means to provide road conditions without requiring the use an expensive video cameras.

Embodiments of the system can also be implemented to help drivers find places to tow their cars if their car breaks down. The system can also be implemented to provide remote diagnostics by sending the on-board computer information to certified car repair shops. The service provider can also allow users to check the road conditions in real time through the Internet by inputting their positions (via e.g., inputting a zip code or correct location parameters).

In one embodiment, user devices may be communicate with the service system in the following manner. Each device has a cognitive radio installed that may keep listening to broadcasting from the service system. This broadcasting message may contain operating channel information, modulation format and other information about the service provider. After the driver device receives the message, the device can start to transmit using the channel and select the best channel for communicating with the server.

Embodiments of the system may implement a variety of revenue models. For example, revenue can be generated by:

1. A user paying a subscription fee each month or depositing a certain amount of money into an account.

2. An advertisement fee based on a user's location, advertisement from restaurants, hotels, gas stations, etc.

3. A user listens to real-time streaming of audio including advertisements. Credit can then be accumulated on the user account after the user listens to a certain amount of radio time. When the user wants to get information from the network, points/credits can be removed from the account for that information.

4. A user can pay a fee on a credit card, an electronic debit card or electronic money.

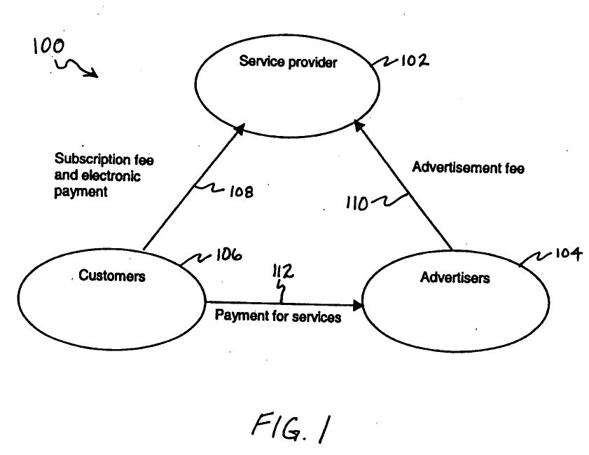

FIG. 1 is a schematic block diagram of an illustrative revenue relationship 100 in accordance with an exemplary embodiment. As shown in FIG. 1, there may be three entities: a service provider 102, one or more advertisers 104 and one or more customers 106. As indicated by arrow 108 subscription fees and electronic payments may be provided by the customers 106 to the service provider 102. Advertisement fees may also be provided to the service provider 102 by advertisers 104 (see arrow 110). Also, payments for services (arrow 112) may be passed from customers 106 to advertisers.

The system may include computer servers, base station, client devices installed on automobiles or carried by drivers. The servers have user databases, manage ID assignments, calculate the speed and provide information to customers.

The traffic information including the average road speed may be provided to drivers using wireless LAN. Color codes can be used to display the information. For example, information displayed in red color can mean that traffic is very slow and information displayed in a green color can mean that traffic running smoothly. In one embodiment, traffic information may be provided to drivers. When a main highway is jammed, the system can allow drivers to select alternative routes and display the area map. This way, a driver can still manage to avoid traffic jams even if the driver is not familiar with the area.

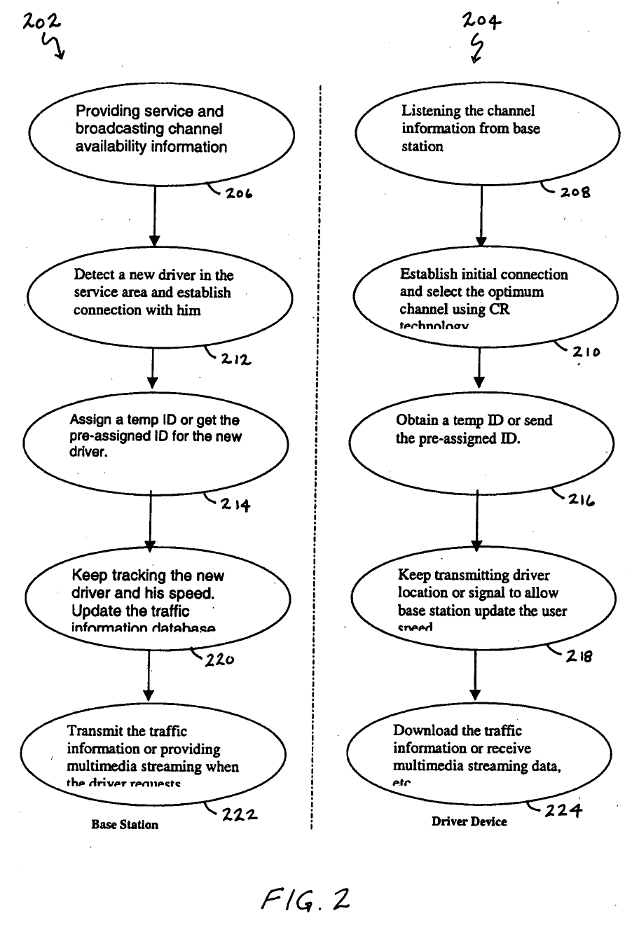

FIG. 2 is a schematic flow diagram of information exchanged between a base station/service provider 202 and driver device 204 (e.g., a remote device) in accordance with one embodiment. As shown in FIG. 2, the base station provides service and broadcasting channel availability information in operation 206. In operation 208, the driver device 204 listens for the channel information from the base station. When this information is obtained, the driver device may establish an initial connection and select an optimum channel using cognitive radio technology and the obtained information in operation 210. In operation 212, the base station/service provider 202 detects the new driver in the service area and in response to the initial connection, establishes a connection with from the driver device 204. In operations 214 and 216, the base station/service provider 202 either assigns and provides to the driver device 204 an a temporary ID or the driver device 204 provides its pre-assigned ID to the base station/service provider 202.

In operations 218 and 220, the driver device 204 periodically or continuously transmits information about the location of the driver device 204 or other signals/information that is tracked by the base station/service provider to permit the base station/service provider 202 to determine or estimate a location of the driver device and its speed of travel. This information is then used to update a traffic information database of the service provider 202. In operation 222, traffic information or other multimedia content may be transmitted by the service provider 202 to the driver device 204. This information may be transmitted in response to a corresponding request by the driver device 204. In operation 224, the transmitted traffic information and/or other content is received and downloaded by the driver device 204.

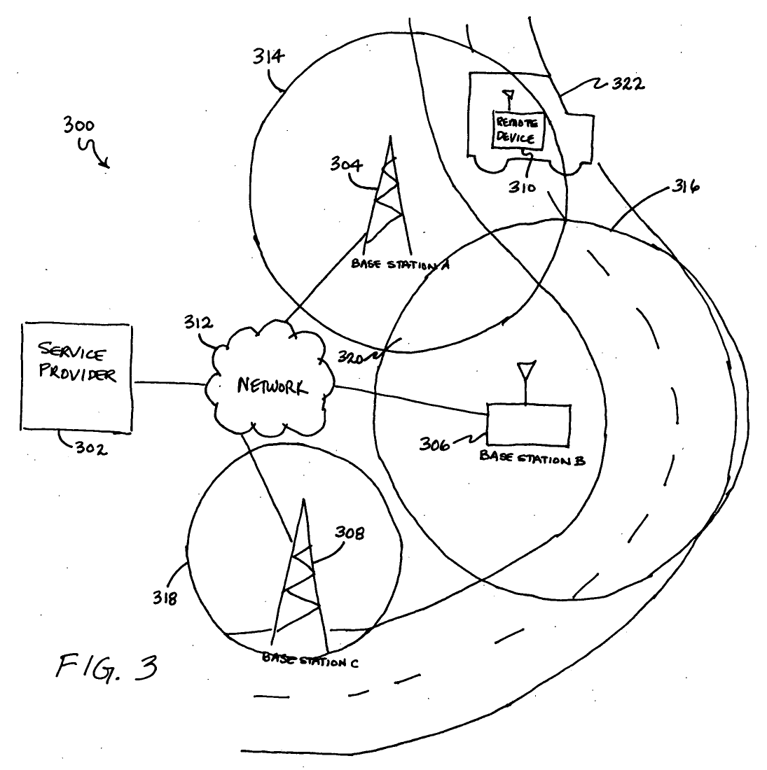

FIG. 3 is a schematic block diagram of an exemplary environment 300 for implementing embodiments described herein. The environment 300 may include a service provider 302, a plurality of access points 304, 306, 308 (that may also referred to as “base stations”) and at least one remote device 310.

The service provider 302 may be coupled to the access points 304, 306, 308 by a network 312 for example. The access points 304, 306, 308 may be capable of wireless communication and, as depicted in FIG. 3, each access point 304, 306, 308 may have an area 314, 316, 318 or range in which wireless communication can be conducted with the corresponding access point. In combination, these zones of communication 314, 316, 318 may collectively define a service area of the service provider 302 in which services and information provided by the service provider may be obtained. As shown in FIG. 3, these zones of communication 314, 316, 318 may or may not have overlapping regions (e.g., overlapping region 320 of zones 314 and 316) in which a device may have wireless communication with each of the access point (e.g., access points 304 and 306) associated with the overlapping zones.

The access points do not necessarily have to comprise the same type of wireless access points (i.e., a homogeneous set of access points) but an embodiment may be implemented where the various access points comprise different types of wireless devices, communicate over different frequency bandwidths, use different communication protocols and so on (i.e., the access points comprise a heterogeneous set of access points). For example, the access points may include 2.5G and 3G wireless networks, wireless LANs or WLAN (e.g., IEEE 802.11 standard wireless networks), and short range wireless networks (e.g., Bluetooth).

The remote device 310 may be located, for example, in a vehicle 322 (e.g., an automobile) and may comprise a wireless device and include a transceiver for permitting the remote device 310 to receive and transmit wireless communications. In one embodiment, the remote device 310 may comprise a cognitive radio device. In the environment, embodiments may be implement so that the remote device 310 may communicate with the service provider 302 when the remote device is within the service are defined by the communicate ranges 314, 316, 318 of the access points 304, 306, 308.

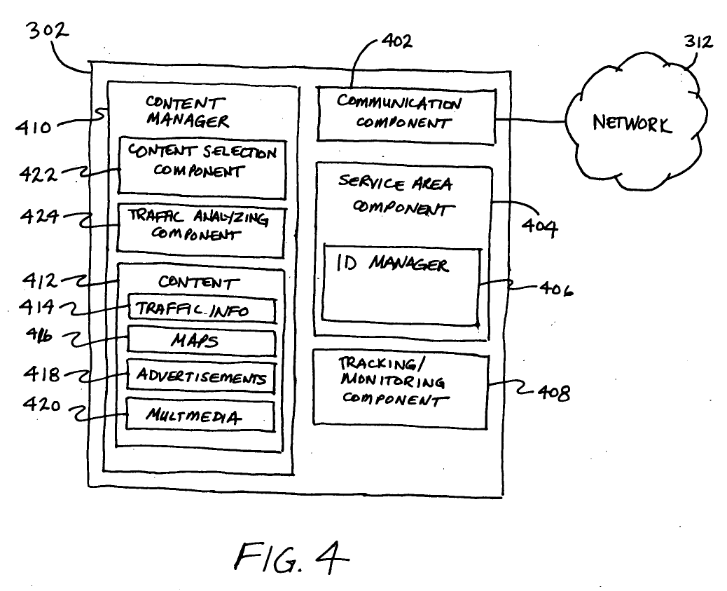

FIG. 4 is a schematic block diagram of an exemplary service provider 302 in accordance with an illustrative embodiment. As shown in FIG. 4, the service provider may include a communication component 402 that may be coupled to a network 312 and that enables communication via the network 312 between the service provider 302, the access points 304, 306, 308 and remote device(s) (e.g., remote device 310) within the service area defined by the communication ranges 314, 316, 318.

The service provider 302 may also include a service area manager 404 that monitors and keeps track of the characteristics of the elements in the service area such as the access points and remote devices. The service area component 404 may include an identifier manager 406 that is used to assign and track identifiers of the system (e.g., pre-assigned and randomly assigned identifiers of the remote device and identifiers used to distinguish the access points from one another).

The service provider 302 may further include a monitoring and tracking component 408 that enables the monitoring and tracking of remote devices in the service area including the tracking and/or monitoring of the location and current speeds of remote devices in the service area. The monitoring and tracking component 408 may also be responsible for estimating the location and speed of the remote devices based on the information obtained from its monitoring and tracking functions.

The service provider 302 may additionally include a content manager component 410 for performing various functions of the service provider 302 relating to content including the creating, selecting and maintaining content. The content manager may have a content store component 412 for storing content such as for example, traffic related information 414, map/geographic information 416 (including route information), advertising information 418 (e.g., advertisements) and/or multimedia content 420. A content selection component 422 may also be included for selecting content for sending to a remote device for presentment to a user proximate to the remote device (e.g., a user of the remote device). A traffic analyzing component 424 may be include for analyzing information obtained from the system and used to create, select and update map and traffic information sent to a remóte use and for providing directional information (e.g., best routes, alternative routes) to the remote device.

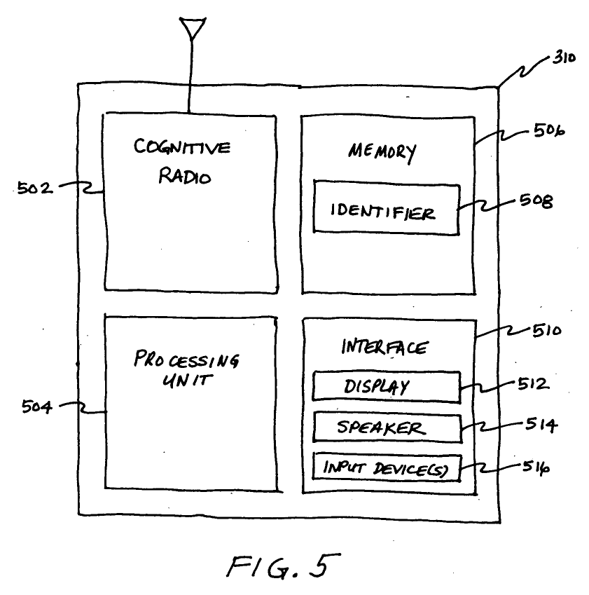

FIG. 5 is a schematic block diagram of an exemplary remote device 310 in accordance with an illustrative embodiment. The remote device 310 may include a radio component 502 that comprises for example a software-defined radio and/or a cognitive radio (and may include a transceiver and an antenna). The remote device 310 may also include a processing unit 504 (e.g., a CPU) enabled to provide various computer functions for the remote device. The remote device 310 may further include a storage component 506 (e.g., a memory store). Content received by the remote device 310 via the system may be stored in the storage component 506. Identifier information 508 may also be stored in the storage component. The identifier information 508 may include, for example, any pre-assigned identifiers associated with the remote device, any identifiers randomly assigned to the remote from by a service provider as well identifier information relating to access points with which the remote device is currently in communication with or has been in communication with.

The remote device 310 may also include an interface component 510 for enabling a user to interface with the remote device. The interface component 510 may, for example, have a display 512 and/or speaker 514 for presenting visual and/or audio content to a user of the remote device 310. The interface component 510 may also include one or more input devices 516 to permit a user to input information and/or commands into the remote device 310.

In accordance with one embodiment, each access point may be assigned a unique identifier that identifies the access point to the service provider. In various implementations of the system, these unique identifiers may be included in communications between the service provider and a remote device so that the communications can be properly routed through the service area and for helping to track the remote device.

In one implementation, a remote device may be provided with the identifier of an access point with an initial communication channel is established between the remote device and the access point. The remote device may then include the access point's identifier in subsequent communications sent from the remote device to the service provider via the given access point.

In another implementation, rather than the remote device including the access point's identifier in its communications, the access point itself may include (e.g., append, attach, wrap and/or encapsulate) its identifier in communications that it receives from the remote device and forwards to the service provider. In either of these implementations, the service provider may then be able to use both the identifier of the remote device (i.e., either a pre-assigned identifier or an identifier selected by the service provider for the remote device) and the identifier of the access point through which the communication between the remote device and service provider was passed may be used (for example, in conjunction with information about the known location of the given access point) to determine and/or estimate a current location, direction of travel and/or speed of the remote device.

The inclusion of an access point's identifier in communications from the service provider to a remote device may also be utilized to help route the communication through the access point so that the service provider can send directed communications to the remote device via the given access point rather than having to broadcast the communication to all access points for subsequent forwarding to the remote device by some or all of the access points receiving the broadcast.

According to the Federal Communications Commission's (FCC) Notice of Proposed Rulemaking on Cognitive Radio (FCC 03-322), which is incorporated herein by reference, a cognitive radio (CR) may be defined as a radio that can change its transmitter parameters based on interaction with the environment in which it operates. Cognitive radio may be capable of detecting user communication needs as a function of use context and provide radio resources and wireless services most appropriate to those needs. A cognitive radio may be capable of sensing whether a particular frequency band is being used and, if unoccupied, the cognitive radio may use the band. When another user (e.g., a primary user) commences transmissions on the band, a cognitive radio may also be able to switch to another frequency band. Thus a device with the ability to gather intelligence and act on it, or act on the intelligence acquired by other devices, may be referred to as a cognitive radio. A device that operates in a shared frequency band may contain varying degrees of cognitive radio to sense their local radio environment and/or detect the presence (and application needs) of other devices that are accessing the same unlicensed band. Cognitive radios may be capable of sensing their radio environment, detecting the presence of other wireless devices, classifying those other devices, and then implement application specific-communications policies. Cognitive radios may also be equipped with location-sensing features to help them determine the manner in which they can most effectively communicate, or in the case of secondary access, whether they may access certain spectrum at all.

In some embodiments, a cognitive radio may comprise a software defined radio. However, it should be understood that neither having software nor being field reprogrammable are necessary requirements of a cognitive radio. In one embodiment, a software defined radio (also referred to as a “software radio”) may be defined as a transmitter in which the operating parameters can be altered by making a change in software that controls the operation of the device without changes in the hardware components that affect the radio frequency emissions. In a software defined radio, functions of a radio may be defined by software. In software defined radio, wireless communication may be implemented in which the transmitter modulation is generated or defined by a computer. Applications may be provided in a software defined radio to control the computer when selecting a desired modulation type. Also, in a software defined radio a receiver may use a computer to recover signal intelligence.

Software-defined radio technology facilitates implementation of some or all of the functional modules in a radio system such as modulation/demodulation, signal generation, coding and link-layer protocols in software. This enables reconfigurable software radio systems where dynamic selection of parameters for each of the above-mentioned functional modules is possible. A radio system built using software-defined radio technology extends the utility of the system for a wide range of applications that use, for example, different link-layer protocols and modulation/demodulation techniques.

A software-defined radio may implement the radio functionality as software modules running on a generic hardware platform. For example, software-defined radio modules may operate on a generic hardware platform comprising digital signal processing and general purpose microprocessors used to implement radio functions such as generation of a transmitted signal at the transmitter and tuning/detection of a received radio signal at the receiver. Further, multiple software modules implementing different standards can be stored in the radio system. Additional software module for implementing new services and/or features can be downloaded to the software-defined radio. A software-defined radio may also provide software control for a variety of modulation techniques, wide-band or narrow-band operation, communications security functions, and waveform requirements of current and evolving standards over a broad frequency range.

A wide range of radio applications including, but not limited to, AM, AMSSB, FM, PSK, QPSK, FSK, AMPS, GSM, Bluetooth, WLAN, GPS, Radar, WCDMA, GPRS, TDMA, QAM, FDMA, TDD, and CDMA, may be implemented using software-defined radio technology. In a software-defined radio system, baseband processing as well as digital down converter and digital up converter functions may be programmable. Link-layer protocols and modulation/demodulation operations may also be implemented in software. The programmability of software-defined radio systems can also be extended to an RF section of a radio (e.g., performing analog to digital conversion and vice-versa at the antenna).

In addition to the call/sector ID process previously described above for determining the location of the remote device, various processes may also be utilized to track and monitor the location of a remote device in a service area. For example, a location determining system may be implemented where time of arrival (TOA) and/or angle of arrival (AOA) techniques may be used. In such an implementation, a network of receivers (e.g., base stations or access points) may be used to measure the time of arrival (TOA) or the angle of arrival (AOA) of a signal from a remote device at a plurality of the access points and use these measurements in some sort of triangulation process to determine the location of the remote device. In one embodiment, a combined angle of arrival and time difference of arrival technique may be used where the time of arrival and the angle of arrival of the signal are measured at two or more receive sites.

In another implementation, the location of a remote device may be monitored as the remote device enters or exits between the frequency ranges of between an access point of one wireless protocol to another. The monitoring also may involve continuous or periodic polling of the remote device or receiving location information pushed from the remote device. Also, other devices in the network may determine a location of the remote device and then push the location information to the service provider.

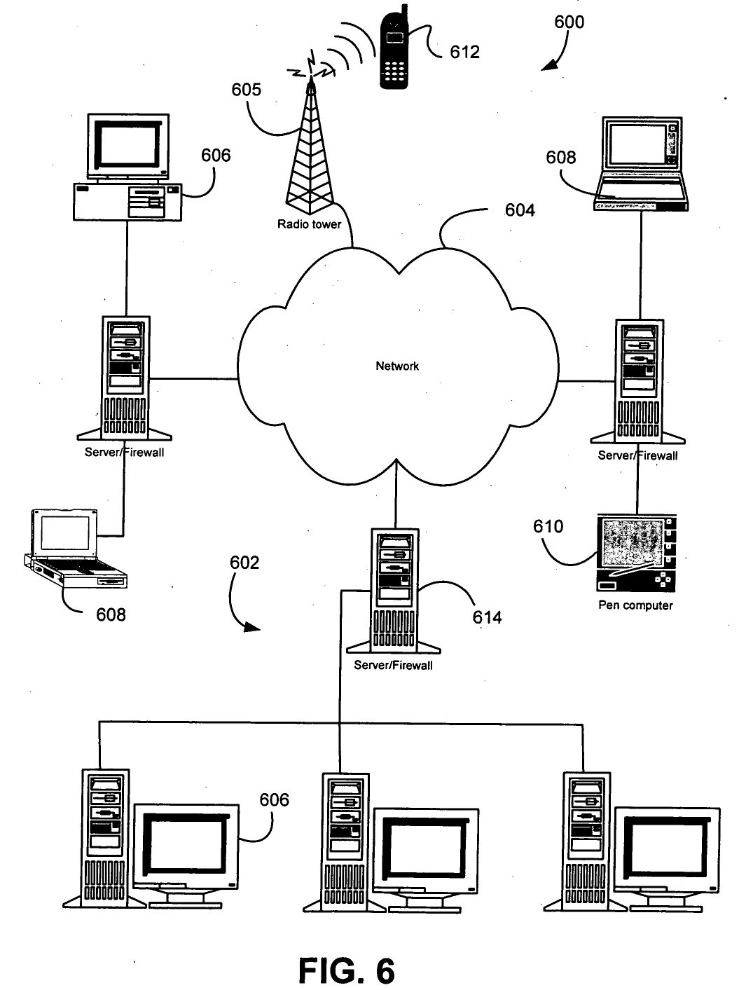

FIG. 6 illustrates an exemplary network system 600 with a plurality of components 602 in accordance with one embodiment. As shown, such components include a network 604 which take any form including, but not limited to a local area network, a wide area network such as the Internet, and a wireless network 605. Coupled to the network 604 is a plurality of computers which may take the form of desktop computers 606, lap-top computers 608, hand-held computers 610 (including wireless devices 612 such as wireless PDA's or mobile phones), or any other type of computing hardware/software. As an option, the various computers may be connected to the network 604 by way of a server 614 which may be equipped with a firewall for security purposes. It should be noted that any other type of hardware or software may be included in the system and be considered a component thereof.

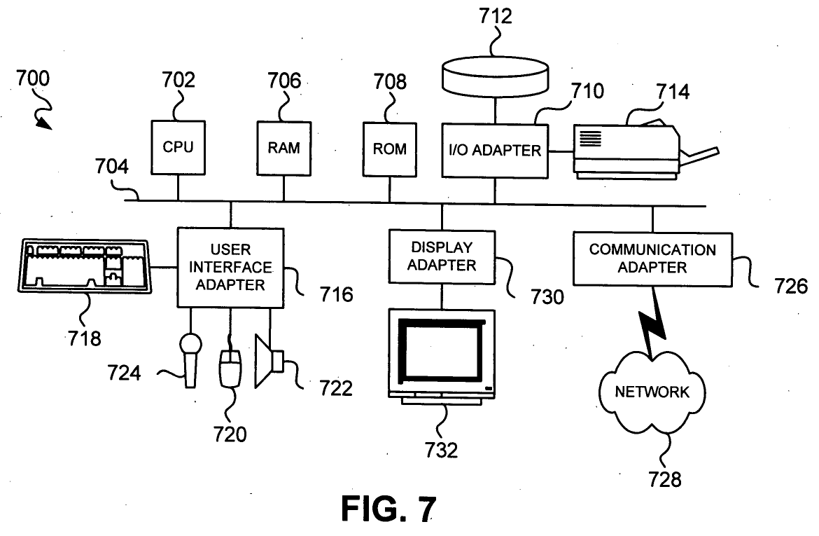

A representative hardware environment associated with the various components of FIG. 6 is depicted in FIG. 7. In the present description, the various sub-components of each of the components may also be considered components of the system. For example, particular software modules executed on any component of the system may also be considered components of the system. In particular, FIG. 7 illustrates an exemplary hardware configuration of a computer 700 having a central processing unit 702, such as a microprocessor, and a number of other units interconnected via a system bus 704. The computer 700 shown in FIG. 7 includes a Random Access Memory (RAM) 706, Read Only Memory (ROM) 708, an I/O adapter 710 for connecting peripheral devices such as, for example, disk storage units 712 and printers 714 to the bus 704, a user interface adapter 716 for connecting various user interface devices such as, for example, a keyboard 718, a mouse 720, a speaker 722, a microphone 724, and/or other user interface devices such as a touch screen or a digital camera to the bus 704, a communication adapter 726 for connecting the computer 700 to a communication network 728 (e.g., a data processing network) and a display adapter 730 for connecting the bus 704 to a display device 732. The computer may utilize an operating system such as, for example, a Microsoft Windows operating system (O/S), a Macintosh O/S, a Linux O/S and/or a UNIX O/S. Those of ordinary skill in the art will appreciate that embodiments may also be implemented on platforms and operating systems other than those mentioned. One of ordinary skilled in the art will also be able to combine software with appropriate general purpose or special purpose computer hardware to create a computer system or computer sub-system for implementing various embodiments described herein.

Embodiments of the present invention may also be implemented using computer program languages such as, for example, ActiveX, Java, C, and the C++ language and utilize object oriented programming methodology. Any such resulting program, having computer-readable code, may be embodied or provided within one or more computer-readable media, thereby making a computer program product (i.e., an article of manufacture). The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

Transmission Control Protocol/Internet Protocol (TCP/IP) is a basic communication language or protocol of the Internet. It can also be used as a communications protocol in the private networks called intranet and in extranet. TCP/IP is a two-layering program. The higher layer, Transmission Control Protocol or TCP, manages the assembling of a message or file into smaller packet that are transmitted over the Internet and received by a TCP layer that reassembles the packets into the original message. The lower layer, Internet Protocol or IP, handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.). Several higher layer application protocols use TCP/IP to get to the Internet. These include the World Wide Web's Hypertext Transfer Protocol (HTTP), the File Transfer Protocol (FTP), Telnet, and the Simple Mail Transfer Protocol (SMTP). These and other protocols are often packaged together with TCP/IP as a “suite.” Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Wireless may refer to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Encryption is the conversion of data into a form, called a ciphertext, that cannot be easily understood by unauthorized people. Decryption is the process of converting encrypted data back into its original form, so it can be understood. Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is often included as part of a web browser. The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet. The private key is used to decrypt text that has been encrypted with the public key. Thus, if a first party sends a message to a second party, the recipient second party may be able to find out the first party's public key (but not the first party's private key) from a central administrator and encrypt a reply message back to the first party using the first party's own public key. When the first party receives the reply message, the reply message may be decrypted by the first party with the first party's private key. In addition to encrypting messages (which ensures privacy), a first party may be able authenticate themselves to second party so that the second party can confirm the identity of the first party (and thus know that it is really the first party who sent the message) by using a private key to encrypt a digital certificate. When the second party receives the encrypted digital certificate, the second party may use the first party's public key to decrypt it.

In accordance with the foregoing, embodiments may be implemented for a carrying out a process for providing content to a remote device. In such a process, a request to establish a connection or communication link with a service provider may be received from a remote device via a wireless access point in a set or network of wireless access points that define a service area of the service provider. A connection or communication link with the remote device may then be established in response to the request and an identifier may be associated with the remote device for the established communication link so that subsequent communications made via the communication link may including the identifier. Communications made via the communication link in the service area may then be monitored utilizing the identifier to determine or estimate a location of the remote device. Based on the determined/estimated location of the remote device, content for the remote device may be selected by the service provider and sent to the remote device via the communication link for subsequent presentment to a user proximate to the remote device.

The remote device may comprises a cognitive radio device. In such an embodiment, the remote device may comprise a software-defined radio. The set of access points may comprise a plurality of heterogeneous access points in which there may be, for example, various access points operating with different frequency bandwidths and/or communication protocols. For example, there may be a first set of access points that operate with a first frequency bandwidth or communication protocol and a second set of access points operating with a second frequency bandwidth or communication protocol different than the first frequency bandwidth/communication protocol.

Prior to receiving the request, the remote device can monitor broadcasts from at least one access point in the service area for information about establishing the communication link with the service provider. The broadcast information that the remote device can be monitoring may include information about an operating channel of the access point, modulation format information and/or information about the service provider. Each of the access points may broadcast information for establishing a communication link with the service provider within a communication range/area of the respective access point. In such an embodiment, the remote device can maintain the communication link with the service provider when passing from a communication range of one access point to a communication range of another access point in the service area by utilizing the information broadcast by the other access point.

The identifier associated with the remote device may comprise a pre-assigned identifier provided by the remote device. The pre-assigned identifier may be provided in/or as part of the initial request by the remote device. As another option, the pre-assigned identifier may be provided in an early communication once the communication link has been established, for example, in response to a request for its identifier issued to the remote device by the service provider.

If the remote device does not have a pre-assigned identifier or does not provide its pre-assigned identifier, the identifier that is associated with the remote device may be randomly selected for the remote device by, for example, either the service provider or the access point through which the communication link is initiated. In one embodiment, the randomly assigned identifier may be returned to a pool of identifiers when the communication link is ended/terminated (i.e., the remote device ceases the communication with the service provider because, for example, the remote device is deactivated or travels out of the service area).

When received by the service provider, communications made by the remote device via the communication link may include information about an access point through which the communication passes (i.e., the access point through which the communication is made). This information can then be used to determine or estimate the location of the remote device. For example, the information about the access point may include information about an identity of the access point and/or information about the link between the remote device and the access point.

The information about the identity of the access point can be utilized to obtain information about a geographic location of the access point. Alternatively, the information about the access point may itself include information about the location (e.g., the geographic area) of the access point. As another example, the information about access point may include information about an operating range of the access point within which a communication link with the access point can be established and maintained. This information can be used to estimate the current location of the remote device (i.e., this information indicates that the remote device is at least within the operating range of the identified access point).

The selected content may comprise map information about a geographic area proximate to the determined/estimated location of the remote device. Alternatively or in addition to the map information, the selected content may include traffic information in a geographic area proximate to the determined/estimated location of the remote device. The traffic information may also include map information. In one embodiment, the service provider may collect information about the locations of one or more additional remote devices located in vehicles in the service area and determines/estimates traffic densities of transport channels (e.g., roads, waterways, rails, subways and/or air) in the service area. From this determination, information relating to the estimated traffic densities may be included in the selected content sent to the remote device.

The selected content may also include advertisements. The selected content may further include information relating to goods and/or service providers (e.g., retailers, services, gas stations, service stations, restaurants, lodging, and/or government services and centers (local, state, federal, police, fire department, schools, and/or hospital) located proximate to the remote device. The content may includes audio content capable of being audibly presented via a speaker coupled to the remote device. The content may also include visual content capable of being visually presented via a visual display coupled to the remote device.

In one embodiment, the service provider may establish an account for the remote device and associate the remote's device assigned identifier to the account. Fees may then be charged to the account for the content transmitted to the remote device. In such an embodiment, a credit may be credited to the account for each advertisement included in the content sent to the remote device. Credits accumulated in the account may be used by an authorized user associated with the remote device to purchase information and other content from the service provider.

Based on the foregoing specification, embodiments of the invention may be implemented using computer programming or engineering techniques including computer software, firmware, hardware or any combination or subset thereof. Any such resulting program—having computer—readable code—may be embodied or provided in one or more computer-readable media, thereby making a computer program product (i.e., an article of manufacture) implementation of one or more embodiments described herein. The computer readable media may be, for instance, a fixed drive (e.g., a hard drive), diskette, optical disk, magnetic tape, semiconductor memory such as for example, read-only memory (ROM), flash-type memory, etc., and/or any transmitting/receiving medium such as the Internet and/or other communication network or link. An article of manufacture containing the computer code may be made and/or used by executing the code directly from one medium, by copying the code from one medium to another medium, and/or by transmitting the code over a network. In addition, one of ordinary skill in the art of computer science may be able to combine the software created as described with appropriate general purpose or special purpose computer hardware to create a computer system or computer sub-system embodying embodiments or portions thereof described herein.

While various embodiments have been described, they have been presented by way of example only, and not limitation. Thus, the breadth and scope of any embodiment should not be limited by any of the above described exemplary embodiments, but should be defined only in accordance with the following claims and their equivalents.

What is claimed:

1. A method for providing content to a remote device, comprising:
receiving a request to establish a link from a remote device, the request being received via an access point in a set of access points that define a service area;
establishing a link with the remote device;
associating an identifier with the remote device for the link, subsequent communications made via the link including the identifier;
monitoring communications made via the link in the service area utilizing the identifier to determine a location of the remote device;
selecting content based on the determined location of the remote device; and
sending the selected content to the remote device via the link for presentment.

2. The method of claim 1, wherein the remote device comprises a cognitive radio.

3. The method of claim 1, wherein the set of access points comprises a plurality of heterogeneous access points.

4. The method of claim 1, wherein prior to receiving the request, the remote device monitors broadcasts in the service area for information about establishing the link.

5. The method of claim 1, wherein the remote device maintains the link when passing from a communication range of one access point to a communication range of another access point in the service area.

6. The method of claim 1, wherein the identifier associated with the remote device comprises a pre-assigned identifier provided by the remote device.

7. The method of claim 1, wherein the identifier associated with the remote device is randomly selected.

8. The method of claim 7, wherein the randomly assigned identifier is returned to a pool of identifiers when the communication link is ended.

9. The method of claim 1, wherein communications made by the remote device via the communication link include information about an access point through which the communication passes.

10. The method of claim 9, wherein the information about the access point includes information about an identity of the access point.

11. The method of claim 9, wherein the information about access point includes information about an operating range of the access point.

12. The method of claim 1, wherein the content comprises map information about a geographic area proximate to the determined location of the remote device.

13. The method of claim 1, wherein the content comprises traffic information in a geographic area proximate to the determined location of the remote device.

14. The method of claim 13, wherein the service provider collects information about the locations of one or more additional remote devices located in the service area and determines traffic densities of transport channels in the service area, and wherein information relating to the traffic densities is included in the content.

15. The method of claim 1, wherein the content includes an advertisement.

16. The method of claim 1, wherein the content include information relating to at least one of a good provider and a service provider proximate to the remote device.

17. The method of claim 1, wherein an account for the remote device is established and the identifier is associates with an account; and wherein fees are charged to the account for the content transmitted to the remote device.

18. The method of claim 17, wherein for each advertisement included in the content, a credit is credited to the account of the remote device.

19. A system for providing content to a remote device, comprising:
logic for receiving a request to establish a link from a remote device, the request being received via an access point in a set of access points that define a service area;
logic for establishing a link with the remote device;
logic for associating an identifier with the remote device for the link, subsequent communications made via the link including the identifier;
logic for monitoring communications made via the link in the service area utilizing the identifier to determine a location of the remote device;
logic for selecting content based on the determined location of the remote device; and
logic for sending the selected content to the remote device via the link for presentment.

20. A computer program product for providing content to a remote device, comprising:
computer code for receiving a request to establish a link from a remote device, the request being received via an access point in a set of access points that define a service area;
computer code for establishing a link with the remote device;
computer code for associating an identifier with the remote device for the link, subsequent communications made via the link including the identifier;
computer code for monitoring communications made via the link in the service area utilizing the identifier to determine a location of the remote device;
computer code for selecting content based on the determined location of the remote device; and
computer code for sending the selected content to the remote device via the link for presentment.
